(19) United States
(12) Patent Application Publication
(10) Pub. No.: US 2001/0047383 A1
(43) Pub. Date: Nov. 29, 2001

(54) System and method for on-demand communications with legacy networked devices

(76) Inventor: Prabal K. Dutta, Columbus, OH (US)

Correspondence Address: PENNIE & EDMONDS LLP, COUNSELORS AT LAW, 3300 Hillview Avenue, Palo Alto, CA, 94304, US

(21) Appl. No.: 09/760,333

(22) Filed: Jan. 12, 2001

Related U.S. Application Data
(60) Provisional application No. 60/176,070, filed on Jan. 14, 2000.

(51) Int. Cl. G06F 15/16

(52) U.S. Cl. 709/201; 709/246

(57) ABSTRACT

A distributed computer system includes a client computer and a server computer configured to communicate with the client computer using a first protocol compatible with the Internet. The system also includes a legacy device configured to communicate using a second protocol. The client computer is configured to send a request to the legacy device via the server computer. The request includes a message. The system further includes a translation program configured to convert the message of the request to the second protocol. The request includes location information of the translation program. The server computer is configured to download the translation program using the location information of the translation program included in the request.

This application claims priority on U.S. provisional patent application serial no. 60/176,070, filed Jan. 14, 2000, hereby incorporated by reference.

### FIELD OF THE INVENTION

The present invention relates to distributed computer systems. More specifically, the present invention is directed to a system that allows servers of the distributed computer systems to communicate with legacy devices connected thereto.

### BACKGROUND OF THE INVENTION

As the Internet is widely accepted as a means to electronically communicate over long distances, new embedded devices and software applications are being developed and produced to operate within the Internet environment. Once the embedded devices and software applications can communicate using the Internet (or other communication network), they can be controlled by, monitored by or exchange messages with remotely located computers.

Embedded devices are computers or microchip-based control devices that are dedicated to perform specific tasks or groups of tasks. Embedded systems are utilized in a variety of industrial and consumer products which include disk drives in computers, automated teller machines at banks, various switching devices and temperature controllers for home appliances such as refrigerators and ovens. The aforementioned software applications are computer programs such as databases, Enterprise Resource Planning (ERP) packages, billing systems and other business software applications.

Unlike newly produced embedded devices and software applications, older embedded devices and software applications implemented before the wide acceptance of the Internet are not capable of communication over the Internet. These embedded devices and applications are herein called legacy systems.

Some of the legacy systems are completely incapable of communicating with outside devices or computers. Those legacy systems that can communication with outside devices do so by using modems and a myriad of propriety communication protocols.

As a result, in order to establish communication between a remote computer and a legacy device for the purpose of sending and receiving messages therebetween, many obstacles must be overcome. First, the legacy device must be able to communicate with outside devices and computers. This is conventionally achieved by using modems. Second, a mechanism for converting messages generated using one communication protocol to another is required. In other words, messages from the computer are required to be converted to a specific propriety communication protocol used by the legacy device. Third, even if the legacy devices are configured to communicate using modems and provided with a mechanism for converting the message to the property protocol, if the remote computer is located a long distance away from the legacy device, then the remote computer must make a long distance telephone call in order to establish a communication link with the legacy device. The financial costs associated with such telephone calls are further explained in conjunction with an exemplary conventional system directed to making readings from meters, which are an example of legacy devices.

Now referring to FIG. 1, a typical prior art system to remotely make readings from meters includes a remotely located computer 11 and a plurality of legacy devices 17, e.g., meters, each of which is remotely located, a long distance away from the computer 11. The computer 11 is connected to a modem 13, and each meter 17 is also connected its respective modem 15. The computer 11 also includes a utility information aggregator software application. The aggregator is configured to collect data from the meters 17 using telephone-based automated meter reading (AMR) technologies and configured to process the collected data and generate corresponding bills.

In operation, the modems 15 connected to the meters 17 dial into the modem 13 connected to the computer 11 using a “toll-free” telephone line. (It is noted that “toll-free” telephone lines or numbers are not, in fact, toll-free. Rather, they are toll-free to the caller. The called party is billed for received calls in accordance with a toll schedule or agreement, the cost of which may vary widely.) Once the telephone links are established, the meters send meter readings through their modems 15. Upon receiving the readings, the aggregator stores them in a database in the computer 11. The stored meter readings are utilized to generate bills.

The cost of the telephone calls could be about $0.05 per minute, billed in $0.01 increments. A typical inbound call from a meter may last approximately 30 seconds, resulting in a $0.03 bill for each call. If each meter calls once a month, the annualized cost of reading that meter is $0.36. If the meter calls every hour, the annualized cost increases to $262.80 for just the one meter. If a system includes ten thousand meters that use this approach, the annual cost of reading the meters skyrockets to $2.628 million.

It is therefore desirable to provide a system and method with which to communicate with legacy systems over the Internet. This would allow a remote computer to send and receive messages to and from legacy devices without having to make long distance telephone calls.

### SUMMARY OF THE INVENTION

The present invention provides a distributed computer system that includes a client computer and a server computer configured to communicate with the client computer using a first protocol compatible with the Internet. The system also includes a legacy device configured to communicate using a second protocol. The client computer is configured to send a request to the legacy device via the server computer. The request includes a message and location information of a translation program configured to convert the message to the second protocol. The server computer is configured to download and execute the translation program using the location information of the translation program included in the request. The server computer need not contain information relating to the legacy device and the translation program before receiving the request from the client computer. The above system can include any number of legacy devices.

The present invention also provides a method of communication in a distributed system. The method includes the steps of receiving a request from a client computer using first protocol compatible with the Internet. The request includes a message, location information of a server computer and location information of a translation program. The legacy device is configured to communicate using second protocol and the translation program is configured to translate messages between the first and second protocols. The method further includes the steps of locating the legacy device and the translation program, and executing the translation program to translate the message to the legacy device.

### BRIEF DESCRIPTION OF THE DRAWINGS

Preferred features of the present invention are disclosed in the accompanying drawings, wherein similar reference characters denote similar elements throughout the several views, and wherein:

FIG. 1 is an illustration of a conventional system for establishing communication links to legacy devices;

FIG. 2 is an illustration of a preferred embodiment of the present invention for establishing communication links to legacy devices using the Internet;

FIG. 3 is a block diagram of various software modules of the present invention;

FIG. 4 is a schematic diagram of a distribution of various devices in a large coverage area for the present invention;

FIG. 5 is a flow chart of a sequence of events that takes place in the present invention.

FIG. 6 is a block diagram of a client computer;

FIG. 7 is a block diagram of a server computer in accordance with a preferred embodiment of the present invention; and

FIG. 8 is a block diagram of a legacy device in accordance with a preferred embodiment of the present invention.

### DETAILED DESCRIPTION OF THE INVENTION

Referring to FIG. 2, a preferred embodiment of the present invention implemented in a client-server environment includes a client computer 21 and one or more server computers 25, 31.

The client computer 21 may be a desktop or personal computer (PC). In alternative embodiments, the client computer 21 may be a Unix workstation. The specific type of processor and operating system used by the client computer is not important to the present invention. The client computer can be operated using Windows®, Linux, Unix, a Web based operating system or other operating systems available in the art. In fact, the client computer 21 is not required to include a microprocessor, as long as the client computer 21 is capable of sending and receiving messages over the Internet with the server computers 25, 31.

The client computer 21 can be linked to the server computers 25, 31 via the Internet. More specifically, the client computer 21 and server computers 25, 31 can be connected through an Internet Service Providers (ISP) via a local telecommunication network, e.g., a local Public Switched Telephone Network (PSTN). The local telecommunication network can be either a wire or wireless communication network.

The server computers 25, 31 preferably include a lookup server computer 25 and one or more routing server computers 31. The lookup and routing server computers 25, 31 are preferably high throughput computers capable of handling a large volume of message traffic. The lookup and routing server computers 25, 31 can be implemented using Unix workstations, PC's, a number of computers connected together for parallel processing, or even a supercomputer. In other embodiments, some of the server computers 25, 31 can be similar in their processing power capacity to the client computer 21.

The lookup computer 25 and the routing computers 31 preferably communicate with each other through a common communication protocol via the Internet. Alternatively, the lookup computer 25 and routing computers 31 can also communicate through a parallel bus, serial bus, or shared memory. It should also be noted that functions to be performed by the lookup server computer 25 and the routing server computers 31 can also be implemented in one computer rather than a plurality of computers.

Referring to FIG. 3, the system illustrated in FIG. 2 further includes a client module 41 (the “client”) residing in the client computer 21, and a server module 43 (the “server”) residing in each routing computer 31 and/or the lookup computer 25. The client 41 and server 43 communicate with each other using a common communication protocol, such as Hypertext Meta Language (HTML), Java, JavaScript, ActiveX/(D)COM, Remote Method Invocation/Jini (RMI/Jini), Extended Meta Language (XML), Common Object Request Broker Architecture (CORBA) or other similar object broker systems available in the art.

As noted above in the Background section, the legacy devices 17A-C, e.g., meters, operate under a number of different propriety protocols. For instance, legacy devices connected to the modems 15A, 15B and 15C may be configured to communicate using three distinct protocols herein called protocols X, Y and Z, respectively. Consequently, when the server 43 is required to send messages to and from the legacy devices, translation programs 45 are required. For instance, for the legacy device 15A operating under X protocol requires a translation program that can convert a message written for the common communication protocol to the protocol X and vice versa. Other translation programs are required to convert between the common protocol and the Y and Z protocols.

In FIG. 3 the dotted lines represent process boundaries. Each of the objects 46 is the software interface in the server that represents the “real object” 47 in a legacy device 17. The server 43 sends translated messages to an interface object 46 as though it were the real object 47. The interface object 46 encapsulates all code and functionality that is needed to exchange messages with the real object 47. Each real object 47 is a driver program and/or hardware in a legacy device that exchanges messages with the server 43 via that interface object 46 and translation program(s) 45 required to enable communication between the legacy device and server.

In terms of object oriented programming, each translation program 45 exposes a common interface to the server and a device-specific proprietary interface to the interface object 46.

Conceptually, a translation program of the present invention is similar to the device drivers of conventional computer systems. An example of the translation program is provided in Table 1.

TABLE 1
// An exemplary translation program
import java.io.*;
public class TranslationProgram
{

public void setInputStream(InputStream is)
{

is_ = is;

}
public void setOutputStream(OutputStream os)
{

os_ = os;

}
public Object invoke(String name, Vector args)
throws MethodNotFoundException
{

if (name.equals() == “readkWh”)
{

return readkWh();

}
else if (name.equals() == “getTime”)
{

. . .

}
. . .
else
{

throw new MethodNotFoundException;

}

}
public Object readkWh()
{

try
{

os_.flush();
os_.write(“G KWH\r\n”); // The proprietary protocol
DataInputStream dis = new DataInputStream(is_);
return dis.readUTF();

}

}
InputStream is_;
OutputStream os_;

}

It follows that for each propriety protocol, an appropriate translation program must be provided. The translation programs can be located in the routing server computer 31, the lookup server computer 25, the client computer 21 or any other computers connected to the network in which the routing server computers 31 have access. In an alternative embodiment, all legacy devices 17A-C connected to the routing server computers 31 may operate under one propriety protocol, in which case just one translation program is needed.

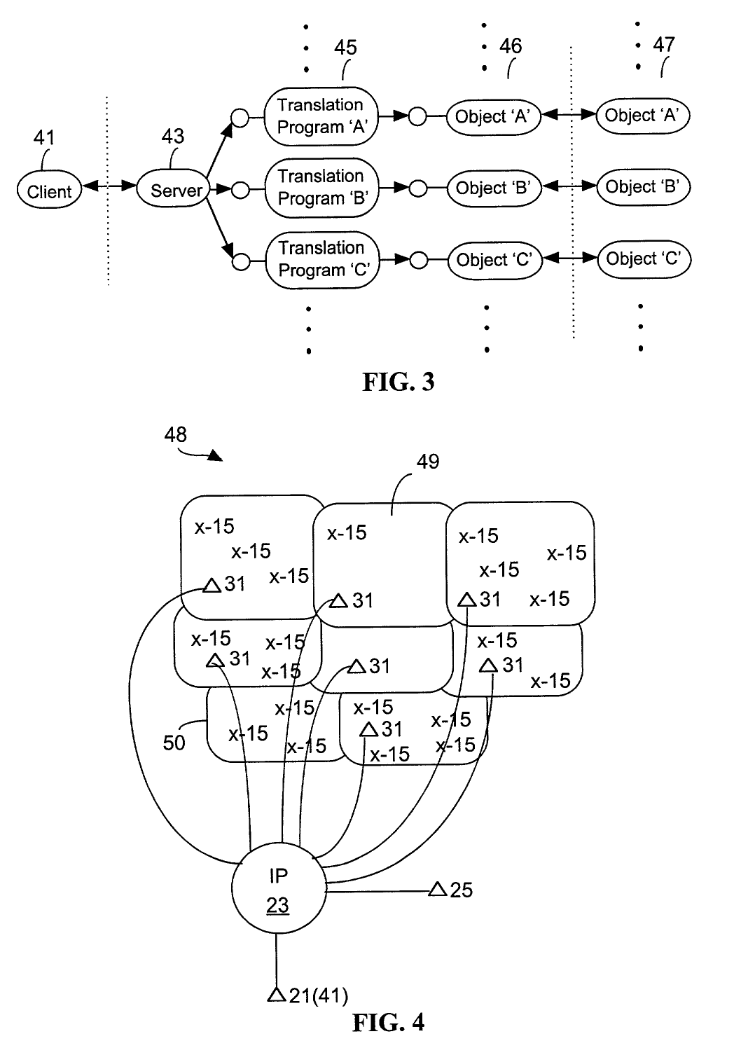

Referring to FIG. 4, the system described above can be deployed to communicate with legacy devices dispersed over a large geographical area 48 that includes a number of local telephone call areas 49, i.e., Point of Presence (POPS). Preferably, a number of modems 15 and corresponding legacy devices and at least one routing server 31 are located within each local telephone call area 49. However, in less ideal configurations, one or more local telephone call areas 50 do not have a routing server.

Each routing server computer 31, connected to a modem 27 can establish communication links with the modems 15 connected to the legacy devices within the respective local telephone call areas 49, 50. Further, the lookup server computer 25 includes a database 33 (FIG. 2) (sometimes called a lookup map) that maps each legacy device 17 to at least one routing server computer 31 located within the same local telephone call area or within the local telephone call area closest thereto. The database 33 can be implemented using conventional database management systems such as ORACLE®, SYBASE® or other similar products. Further, the database 33 can also be implemented by standard spread sheet software programs such a Excel and LOTUS 123®.

In operation, the client 41 is configured to send a request to the server 43. The request includes information related to the address of the legacy device the request is destined to, the address of the translation program for the legacy device, and a set of commands to be performed by the legacy device. In particular, the address of the legacy device can be the telephone number with which the modem of the legacy device can be reached, the address of the translation program can be an HTTP address, and the commands can be controlling, data collecting or otherwise operational messages to the legacy device.

The client can also include a client application, e.g., a spread sheet program such as Excel or Lotus 123®, configured to send requests regularly, e.g., every month to each of the legacy devices. More specifically, the client application can send requests to each legacy devices. The requests are first received by the lookup server 31. The database 33 of the lookup server 25 maps each legacy device to the respective routing servers 31 located within the respective local telephone call areas. When there is no routing server within a local telephone call area, the legacy devices in such area are mapped to a routing server closest thereto in the lookup server.

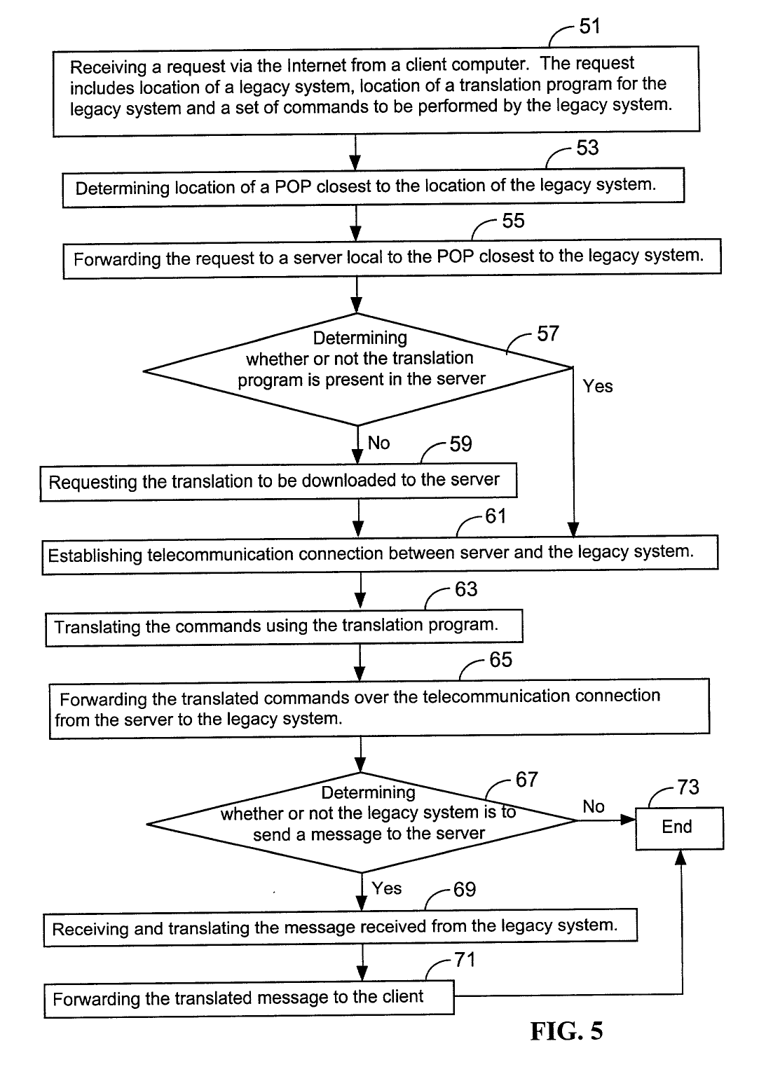

As shown in FIG. 5, once the appropriate routing server 31, located either in the same local telephone call area or a call area located closest to the legacy system, is identified in accordance with predefined selection criteria (step 53), the requests are forwarded to the identified routing server (step 55). Upon receiving the request, the routing server initially determines whether or not the translation program is already loaded (step 57). If there is no translation program already loaded, then the routing server downloads the designated translating program (step 59).

The routing server 31 then establishes a communication link with the respective legacy device (step 61). As discussed above the communication link is preferably established via a local PSTN, and the link can be over a wire/wireless communication network. The routing server 31 then converts the messages from the common communication protocol into messages that the legacy device can understand (step 63). Once the messages have been translated into a message that the legacy devices can understand, the translated messages are then sent to the legacy device over the communication link (step 65). The routing server 31 further determines whether or not there was any error during the steps of down loading the translation program or converting the message. If there is an error, an error message is sent to the client.

The routing server 31 also determines whether or not a return message is expected (step 67). If no return message is expected then the communication link is disconnected (step 73). If a return message is expected then the routing server awaits the message from the legacy device. Once the message is received from the legacy device (step 69), the message is translated back to the protocol than can be understood by routing computer and the client. The translated message is then forwarded to the client (step 71).

In another aspect of the present invention, the legacy devices 17 can initiate the communication process. In particular, each legacy device 17 can be programed to send one or more requests to the client 21. The requests from the legacy devices are forwarded to the respective routing server 31 through the modems 15. The routing server 31 is preferably further configured to receive the requests and to identify the source of the requests by identifying the legacy devices by their modem's telephone numbers, e.g., by using a caller ID device.

In this embodiment, a second database (sometimes called a lookup map) is provided that maps the legacy device's identification (e.g., telephone number) with corresponding translation programs and location information for the translation programs. The second database can be located in each of the routing servers 31. In this embodiment, the database can include location information for only those translation programs relating to the legacy devices within its local telephone call area and the closest local telephone call area or areas, if any, that do not have a routing server.

Once the location of the translation program is identified, then the routing server downloads and executes the translation program, thereby converting the message from the legacy device. The converted message is then forwarded to the client.

It should be noted that the routing servers 31 are not required to know the legacy device's existence, location or identifier. The routing servers 31 simply respond to incoming messages or calls in the appropriate manner, performing message protocol translations identified in the messages, and then forwarding the message to the identified target system or device.

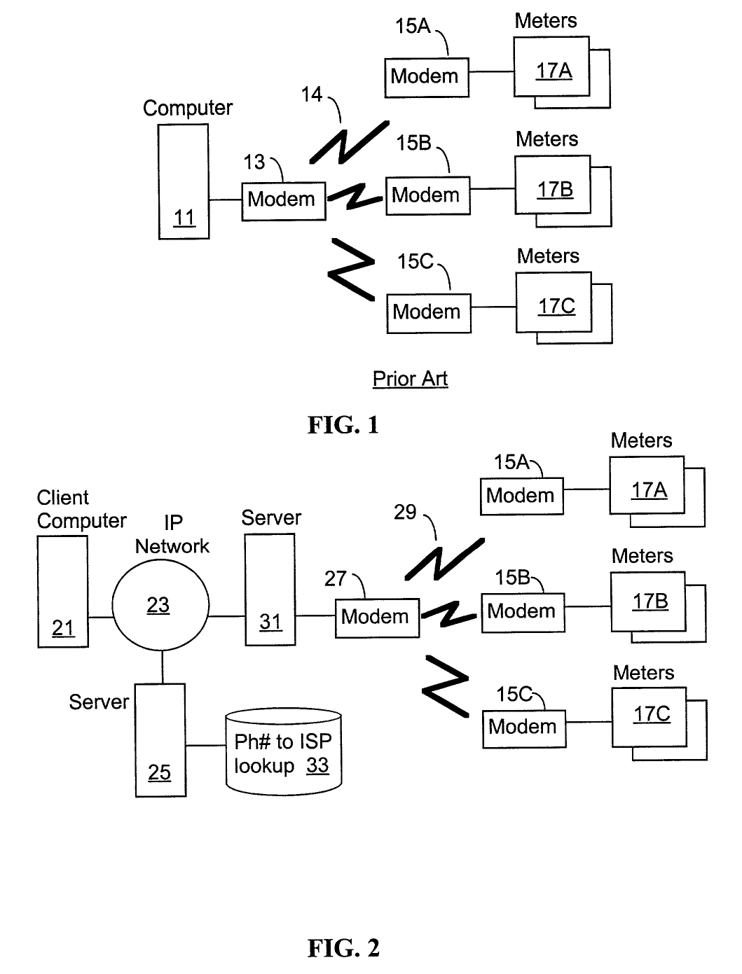

Unlike the conventional system depicted in FIG. 1, the client computer 21, the lookup computer 25 and the routing computers 31 can be located long distances away from each other without having to make long distance telephone calls to send messages between the client computer 21 and the legacy devices 17. This advantage is more apparent in the following exemplary embodiment.

### Meter Embodiment

As noted above, for a client computer to send and receive a message to a legacy device that can communication via a modem but cannot communicate via the Internet, the client computer must establish a telecommunication link. When the legacy device is not located within a local telephone call area, long distance telephone calls have to be made. As discussed in the Background section, when a large number of legacy devices must be called, the long distance telephone charge can accumulate to become a significant financial burden.

This is more apparent with many companies' that may need to aggregate, analyze and distribute data collected from modem-enabled legacy devices as part of day to day operation. In particular, for an electrical or water utility company, a utility information aggregator may collect data from meters using telephone-based automated meter reading (AMR) technologies, and then present and process bills for the regional utility. In many cases, an application located in a remote data center can establish communication links with the meters using a toll-free or other long distance telephone service. As discussed above, the cost of making such telephone calls can become a significant portion of operating expense.

In the present invention, instead of using a toll-free telephone connection as discussed above, the communication between the meters and the data center can be achieved via the Internet. As an example, the following request can be sent to the Internet from a computer in the data center:

http://server/program?phone=6145551212&translatorrepository/translator.class=com.meter.device&method=readkWh

The above example request, when executed by a server, causes the application located in remote data center to establish a communication link with a modem located at the telephone number “614-555-1212” and download translation program located in “com.meter.devce.” In turn the translation program converts the commands so that the converted command, e.g., “readkWh”, read Kilo wattage, can be executed by a meter connected to the modem.

### Client, Server and Legacy Systems

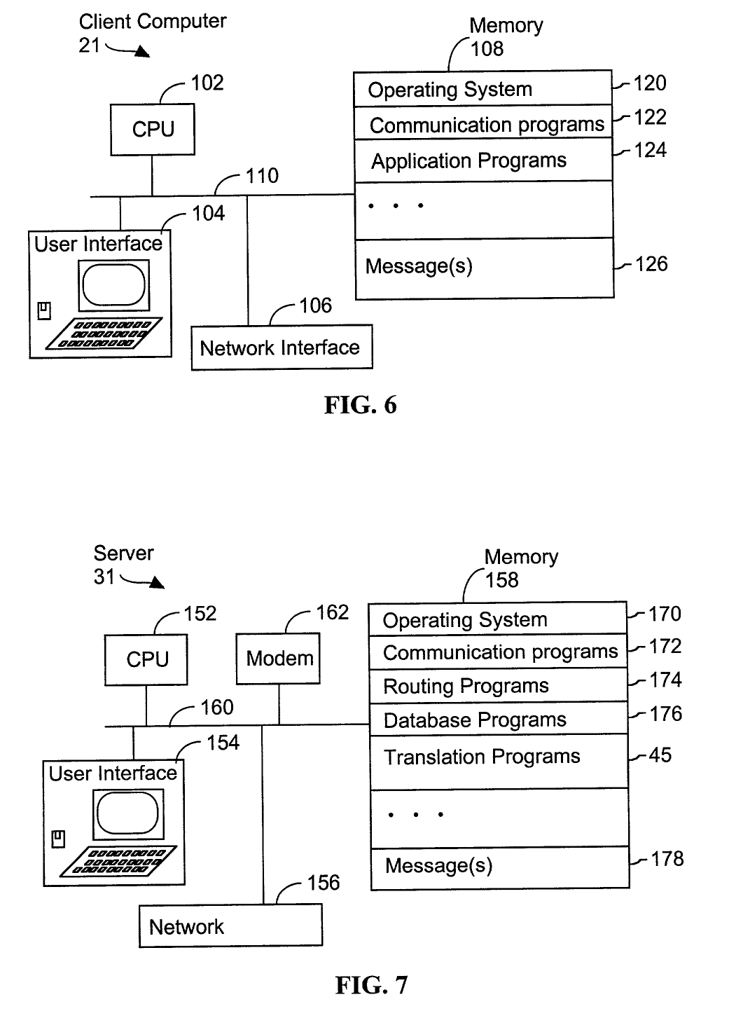

Referring to FIG. 6, the client computer 21 will typically include one or more central processing units 102, a user interface 104, a network interface 106 for communicating with servers and other devices via a communication network such as the Internet, memory 108, and one or more system busses 110 interconnecting these components. Memory 108, which may include both high speed random access memory as well as non-volatile memory such as disk memory, typically stores programs and data such as:

an operating system 120 for performing basic system functions;

communication programs 122 for handling communications via the network interface 106;

application programs 124, such as accounting programs and other programs that may be used to remotely control legacy devices; and

messages 126, such as messages sent by the client computer to legacy devices and vice versa.

Referring to FIG. 7, the server computer 31 will typically include one or more central processing units 152, a user interface 154, a network interface 156 for communicating with client computers and other devices via a communication network such as the Internet, memory 158, one more modems 162, and one or more system busses 160 interconnecting these components. Memory 158, which may include both high speed random access memory as well as non-volatile memory such as disk memory, typically stores programs and data such as:

an operating system 170 for performing basic system functions;

communication programs 172 for handling communications via the network interface 156 and modem(s) 162;

one or more routing programs 174 for routing messages to their destination;

one or more database programs 176, such as for determining the routing server located with the same local telephone call area of a specified legacy device;

translation programs 45 for translating messages between protocols, as described above; and

messages 178, such as messages sent by the client computer to legacy devices and vice versa.

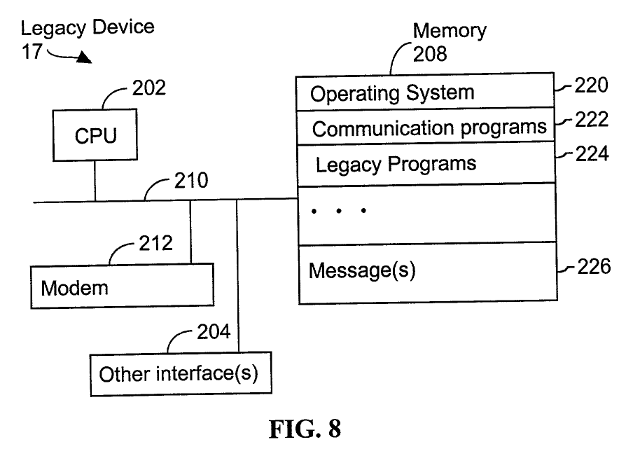

Referring to FIG. 8, a typical legacy device includes one or more central processing units 202, interfaces 204 for communicating with or controlling various components of the legacy device, a modem 212 for communicating with servers and other devices via the PSTN or other network, memory 208, and one or more system busses 210 interconnecting these components. Memory 208, which may include both high speed random access memory as well as non-volatile memory such as ROM, flash or disk memory, typically stores programs and data such as:

an operating system 220 for performing basic system functions;

communication programs 222 for handling communications via the modem 212;

legacy programs 224, for controlling or operating the legacy device and/or for retrieving status information about the legacy device; and

messages 226, such as messages sent by a client computer to the legacy device and vice versa.

Although the preferred embodiments of the invention have been described in the foregoing description, it will be understood that the present invention is not limited to a water heating mechanism in a coffee brewer. It should be understood that the materials used and the mechanical detail maybe slightly different or modified from the description herein without departing from the methods and composition disclosed and taught by the present invention as recited in the claims.

What is claimed is:

1. A distributed computer system comprising:
a first entity;
a second entity configured to communicate with the first entity using a first protocol;
a third entity configured to communicate using a second protocol wherein the first entity is configured to send a request to the third entity via the second entity and wherein the request includes a message; and
a translation entity configured to convert the message of the request to the second protocol, wherein the request further includes location information of the translation entity and wherein the second entity is configured to download the translation entity using the location information of the translation entity included in the request.

2. The system according to claim 1 wherein the second entity does not contain information relating to the third entity and the translation entity before receiving the request from the first entity.

3. The system according to claim 1 wherein the translation entity is located in one of the first and second entities.

4. The system according to claim 1 wherein the first entity includes a Web browser to communicate with the second entity.

5. The system according to claim 1 wherein the first protocol is compliant with Common Object Broker Architecture.

6. The system according to claim 1 wherein the second protocol is a proprietary protocol unique to the third entity.

7. The system according to claim 1 wherein the third entity is further configured to send a second request that includes a second message to the first entity via the second entity and the translation entity is further configured to covert the second request to the first protocol and wherein the second entity is configured to locate, download and execute the translation entity to convert the second message to the first protocol.

8. The system according to claim 1 wherein the second entity comprises:
a first computer configured to store the location information of the translation entity;
and
a second computer configured to download and execute the translation entity, wherein the second computer is further configured to establish a communication link with the third entity.

9. The system according to claim 8 further comprising:
a first modem connected to the second entity; and
a second modem connected to the third entity, wherein the communication link is established via the modems.

10. The system according to claim 8 wherein the first computer includes a database to store the location information of the translation entity.

11. The system according to claim 8 wherein the communication link is established via a telephonic public switched telephone network.

12. A distributed computer system comprising:
a first entity;
a second entity configured to communicate with the first entity using a first protocol;
a plurality of third entities each of which is configured to communicate using a respective one of a plurality of second protocols; and
a plurality of translation entities each of which is configured to convert the message of the request to a respective one of the plurality of second protocols;
wherein
the first entity is configured to send a request to one of the third entities via the second entity;
the request includes a message and location information of the one of the third entities, and further includes location information of one of the translation entities that converts the message to the respective second protocol used by one of the third entities to communicate; and
the second entity is configured to download the one of the translation entities using the location information included in the request.

13. The system according to claim 12 wherein the second entity does not contain information relating to the third entities and the translation entities before receiving the request from the first entity.

14. The system according to claim 12 wherein the translation entities are located in one of the first and second entities.

15. The system according to claim 12 wherein
the second entity includes a server computer of an Internet Service Provider, and
the first and second entities are configured to communicate via the Internet.

16. The system according to claim 12 wherein the first protocol is compliant with Common Object Broker Architecture.

17. The system according to claim 12 wherein the second protocols are proprietary protocols unique to the corresponding second entities.

18. The system according to claim 12 wherein the second entity comprises:
a first computer configured to store the location information of the translation entities;
and
a second computer configured to download and execute the translation entity, wherein the second computer is further configured to establish a communication link with the third entities.

19. The system according to claim 18 further comprising:
a first modem connected to the second entity; and
a plurality second modems connected to the third entities, wherein the communication links are established via the modems.

20. The system according to claim 12 wherein at least one of the third entities is further configured to send a second request that includes a second message to the first entity via the second entity and the second entity is configured to download and execute one of the translation entities, to thereby convert the second request to the first protocol.

21. The system according to claim 20 further including an address lookup map, wherein second entity is further configured to use the address lookup map to locate one of the translation entities and to execute the one of the translation entities for converting the second message.

22. The system according to claim 21 wherein the address lookup map is configured to map a telephone number associated with the third entities to the corresponding translation entity.

23. A method of communicating in a distributed system comprising:
receiving at a first entity a request from a client entity using a first protocol, wherein the request includes a message, location information of a second entity and location information of a translation entity, and wherein the second entity is configured to communicate using a second protocol and the translation entity is configured to translate messages between the first and second protocols;
locating the second entity and the translation entity; and
executing the translation entity to translate the message to the second protocol.

24. The method according to claim 23 further comprising:
configuring at least one client entity to communicate using the first protocol and to send a plurality of messages to the first entity, wherein the messages include information relating to locations of the second and translation entities.

25. The method according to claim 24 further comprising:
configuring the first entity so that no information relating to the second and translation entities is contained therein before receiving the message from the client entity.

26. The method according to claim 24 further comprising:
locating the translation entity in one of the client, first and second entities.

27. The method according to claim 24 further comprising:
configuring the first and client entities are configured to communicate via the Internet wherein the first entity is a server computer of an Internet Service Provider.

28. The method according to claim 23 further comprising:
configuring the first protocol to be compliant with Common Object Broker Architecture.

29. The method according to claim 23 wherein the second protocol is a proprietary protocol unique to the second entity.

30. The method according to claim 23 further comprising:
configuring the second entity to send a second message to the first entity and configuring the first entity to locate, download and execute the translation entity to convert the second message to the first protocol.

31. The method according to claim 23 further comprising:
configuring the first and second entities to communicate via a pair of modems.

32. The method according to claim 23 farther comprising:
configuring first entity to receive a message from the second entity, to use an address lookup map to locate the translation entity and to execute the translation entity for translating the message.

33. The method according to claim 32 further comprising:
configuring the address lookup map to map a telephone number associated with the second entity to the corresponding translation program.
